(19) United States
(12) Patent Application Publication
(10) Pub. No.: US 2026/0112122 A1
(43) Pub. Date: Apr. 23, 2026

(54) AUTOMATIC CODE GENERATION FOR THREE-DIMENSIONAL VIRTUAL OBJECTS

(71) Applicant: Roblox Corporation, San Mateo, CA (US)

(72) Inventors: Arjun GUHA, Wellesley, MA (US); Francesca LUCCHETTI, Boston, MA (US); Kartik AYYAR, San Mateo, CA (US)

(73) Assignee: Roblox Corporation, San Mateo, CA (US)

(21) Appl. No.: 19/364,257

(22) Filed: Oct. 21, 2025

Related U.S. Application Data
(60) Provisional application No. 63/709,853, filed on Oct. 21, 2024.

(51) Int. Cl. G06T 19/00; G06F 8/35; G06N 20/00

(52) U.S. Cl. CPC G06T 19/00; G06F 8/35; G06N 20/00

(57) ABSTRACT

Some implementations relate to methods, systems, and computer readable media for generating code based on three-dimensional (3D) virtual assets. A 3D model of a 3D virtual object is received. A latent representation of the 3D model is generated using a pre-trained encoder, and encodes semantic and structural information of the 3D model. A text prompt and the latent representation of the 3D model are provided as input to a code generation model, where the text prompt includes a request to generate code with references to the 3D virtual object and where the latent representation of the 3D model serves as a conditioning input to the code generation model. The code is generated by the code generation model upon execution on a virtual platform or a client device, and causes the virtual platform or client device to perform one or more actions with reference to the 3D virtual object.

### CROSS-REFERENCE TO RELATED APPLICATIONS

This application claims priority to U.S. Provisional Ser. No. 63/709,853 , filed Oct. 21, 2024 and titled “AUTOMATIC CODE GENERATION FOR THREE-DIMENSIONAL VIRTUAL OBJECTS,” the entire contents of which are incorporated by reference herein.

### TECHNICAL FIELD

This document relates generally to code generation, and more particularly but not exclusively, relates to methods, systems, and computer-readable media to generate code based on three-dimensional (3D) virtual assets using an artificial intelligence (AI) approach.

### BACKGROUND

Current approaches to generating code for virtual experiences face significant limitations when dealing with 3D virtual assets. Code generation models may operate primarily based on textual inputs, which limits their ability to effectively incorporate information about 3D environments. The models, while useful for generating code from development environments, struggle when context is required regarding 3D object manipulation and representation, such as in games, virtual reality (VR), and/or augmented reality (AR) platforms. The gap results in poor quality code that lacks accuracy, leading to hallucinated outputs, e.g., code that is syntactically correct but semantically irrelevant or inappropriate for the specific 3D context.

Some artificial intelligence (AI) models, such as large language models (LLMs) trained on programming data, have demonstrated strong capabilities in understanding natural language prompts and converting them into code. Such models do not have the capability to interpret and analyze visual inputs or spatial information, which may be important in 3D environments. Consequently, software developers must manually code specific interactions and adjustments for 3D models, making the creation of virtual experiences (in which 3D objects/assets are used as to simulate various objects, avatars, etc. and their behavior, e.g., animation, deformations, and/or interactions with other objects with a virtual experience) labor-intensive and prone to human error.

Some AI models can produce 3D content, such as 3D meshes (mesh generation models) or scene reconstruction from images (scene generation models), but the models do not include code generation capabilities. Current solutions include separate stages for generating 3D assets and writing code, making development fragmented and inefficient. Developers must alternate between tools—one for creating or importing 3D models, and another for scripting behaviors and interactions. The separation not only slows down the development cycle but increases the risk of inconsistencies between the generated models and the behavior scripts.

The background description provided herein is for the purpose of presenting the context of the disclosure. Work of the presently named inventors, to the extent it is described in the background section, as well as aspects of the description that may not otherwise qualify as prior art at the time of filing, are neither expressly nor impliedly admitted as prior art against the prior disclosure.

### SUMMARY

Various implementations described herein relate to methods, systems, and computer-readable media to generate code based on 3D virtual assets using an AI approach.

According to one aspect, to generate code based on representations of 3D virtual objects, a 3D model of a 3D virtual object is received. A latent representation of the 3D model is generated using a pre-trained encoder, where the latent representation of the 3D model encodes semantic and structural information of the 3D model. A text prompt and the latent representation of the 3D model are provided as input to a code generation model, where the text prompt includes a request to generate code with references to the 3D virtual object and where the latent representation of the 3D model serves as a conditioning input to the code generation model. The code is generated by the code generation model upon execution on a virtual platform or a client device, and causes the virtual platform or client device to perform one or more actions with reference to the 3D virtual object.

In some implementations, generating the latent representation of the 3D model using the pre-trained encoder includes providing a set of images depicting respective views of the 3D model to the pre-trained encoder, where the latent representation of the 3D model is based on the set of images.

In some implementations, the code generation model is trained by providing embeddings derived from multiview images of a set of prior 3D models.

In some implementations, each embedding of the embeddings derived from the multiview images is paired with corresponding script data, and training the code generation model includes performing supervised learning based on the embeddings and the corresponding script data.

In some implementations, the code generation model is trained by providing embeddings derived from multiview images of a set of prior 3D models, where the code generation model includes a pre-trained transformer and where the training includes finetuning the pre-trained transformer.

In some implementations, prior to providing the latent representation of the 3D model as an input to the code generation model, the latent representation is compressed.

In some implementations, compressing the latent representation is performed by a perceiver module that implements a learned pooling mechanism.

In some implementations, the code is in a scripting language, and the code is stored in association with the 3D model of the 3D virtual object, where the 3D virtual object is loaded into a virtual experience running on the virtual experience platform or the client device, and where the code is available for execution in response to one or more events that take place in the virtual experience.

According to another aspect, a system includes one or more processors and memory coupled to the one or more processors storing instructions that, when executed by the one or more processors, cause the one or more processors to perform operations. The operations include generating a latent representation of the 3D model using a pre-trained encoder, where the latent representation of the 3D model encodes semantic and structural information of the 3D model. A text prompt and the latent representation of the 3D model are provided as input to a code generation model, where the text prompt includes a request to generate code with references to the 3D virtual object and where the latent representation of the 3D model serves as a conditioning input to the code generation model. The code is generated by the code generation model upon execution on a computing device, and causes the computing device to perform one or more actions with reference to the 3D virtual object. In some implementations, the computing device may be a virtual experience platform or one or more client devices that are used by users participating in a virtual experience.

In some implementations, generating the latent representation of the 3D model using the pre-trained encoder includes providing a set of images depicting respective views of the 3D model to the pre-trained encoder, where the latent representation of the 3D model is based on the set of images.

In some implementations, the operations further include training the code generation model by providing embeddings derived from multiview images of a set of prior 3D models.

In some implementations, the one or more actions include modifying a physical property of the three-dimensional virtual object based on simulated interactions within the virtual environment.

In some implementations, the one or more actions include changing a visual, spatial, or behavioral attribute of the three-dimensional virtual object in response to input from an avatar or system event.

In some implementations, the operations further include training the code generation model by providing embeddings derived from multiview images of a set of prior 3D models, where the code generation model includes a pre-trained transformer and where the training includes finetuning the pre-trained transformer.

In some implementations, the operations further include compressing the latent representation prior to providing the latent representation of the 3D model as an input to the code generation model.

According to another aspect, a non-transitory computer-readable medium with instructions stored thereon is provided that, when executed by a processor, cause the processor to perform operations. The operations include generating a latent representation of the 3D model using a pre-trained encoder, where the latent representation of the 3D model encodes semantic and structural information of the 3D model. A text prompt and the latent representation of the 3D model are provided as input to a code generation model, where the text prompt includes a request to generate code with references to the 3D virtual object and where the latent representation of the 3D model serves as a conditioning input to the code generation model. The code is generated by the code generation model upon execution on a virtual experience platform or a client device, and causes the virtual experience platform or client device to perform one or more actions with reference to the 3D virtual object.

In some implementations, generating the latent representation of the 3D model using the pre-trained encoder includes providing a set of images depicting respective views of the 3D model to the pre-trained encoder, where the latent representation of the 3D model is based on the set of images.

In some implementations, the operations further include training the code generation model by providing embeddings derived from multiview images of a set of prior 3D models.

In some implementations, the operations further include training the code generation model by providing embeddings derived from multiview images of a set of prior 3D models, where the code generation model includes a pre-trained transformer and where the training includes finetuning the pre-trained transformer.

In some implementations, the operations further include compressing the latent representation prior to providing the latent representation of the 3D model as an input to the code generation model.

According to yet another aspect, portions, features, and implementation details of the systems, methods, and non-transitory computer-readable media may be combined to form additional aspects, including some aspects which omit and/or modify some or portions of individual components or features, include additional components or features, and/or other modifications, and all such modifications are within the scope of the disclosure.

### BRIEF DESCRIPTION OF THE DRAWINGS

FIG. 1 is a diagram of an example system architecture to train a code generation model on 3D virtual assets and use it for code generation for a 3D virtual environment, in accordance with some implementations.

FIG. 2 is a flow diagram illustrating an example method 200 to generate code based on 3D virtual assets using an AI approach, in accordance with some implementations.

FIG. 3 is a flow diagram illustrating a 3D multimodal encoder-decoder architecture to integrate 3D virtual assets into code generation, in accordance with some implementations.

FIG. 4A is a diagram illustrating an example of a 3D model of an object that is a virtual asset, in accordance with some implementations.

FIG. 4B is a diagram illustrating an example of code generated by a code generation model based on 3D latent embeddings of a 3D virtual asset, in accordance with some implementations.

FIG. 5 is a block diagram that illustrates an example computing device, in accordance with some implementations.

### DETAILED DESCRIPTION

In the following detailed description, reference is made to the accompanying drawings, which form a part hereof. In the drawings, similar symbols identify similar components, unless context dictates otherwise. The illustrative implementations described in the detailed description, drawings, and claims are not meant to be limiting. Other implementations may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “one implementation”, “an implementation”, “an example implementation”, “some implementations”, etc. indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, such feature, structure, or characteristic may be effected in connection with other implementations whether or not explicitly described.

The present disclosure is directed towards, inter alia, techniques to generate code based on 3D virtual objects by conditioning a code generation model on latent representations of those objects. In various implementations, a 3D model of a virtual object is received and analyzed using a pre-trained encoder to generate a latent representation. The latent representation encodes both semantic and structural attributes of the 3D model. In various implementations, structural attributes can include geometry (e.g., vertex positions, mesh connectivity), topology (e.g., edge loops, surface continuity), and component relationships (e.g., parent-child hierarchies of articulated parts). In various implementations, semantic attributes can include object category (e.g., fruit, vehicle, tool, character), functional or behavioral properties (e.g., movable versus static, rigid versus deformable), and contextual tags inferred from prior training examples. This representation can serve as a conditioning input (i.e., an input that guides the output distribution) of a code generation model configured to emit code representations associated with the 3D model.

In some implementations, a code generation model receives a text prompt that includes a request for code to interact with or apply to the 3D virtual object. The code generation model is trained and/or fine-tuned to interpret the prompt in the context of the latent representation, enabling the code generation model to output executable code that references or manipulates the 3D object in a virtual environment. In some implementations, the generated code may, for example, attach the object to an avatar (e.g., equipping a hat or wearable object), apply physics properties (e.g., making a soccer ball bounce realistically upon contact), trigger animations (e.g., playing a “door open” animation when a handle is clicked), or modify environment behaviors based on the presence of the object (e.g., triggering ambient lighting changes when a glowing orb is placed in a room, spawning non-player characters when a portal is instantiated, or disabling movement in an area until a key object is detected).

### System Architecture

The present disclosure is directed towards, inter alia, techniques to generate contextually relevant code for 3D virtual assets by utilizing representations of their geometric and semantic properties as input to an AI model.

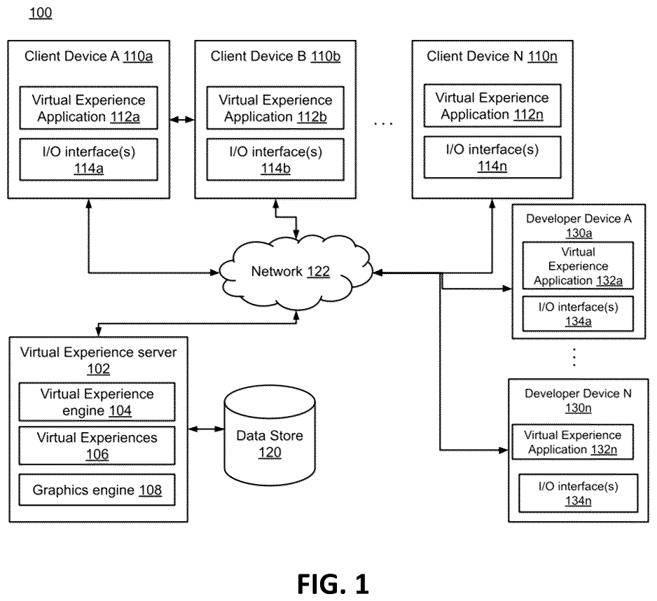

FIG. 1 is a diagram of an example system architecture that can be used for tracking body movements of players without user-perceptible lag using a single camera feed on devices that may have limited computational processing power. FIG. 1 and the other figures use like reference numerals to identify similar elements. A letter after a reference numeral, such as “110,” indicates that the text refers specifically to the element having that particular reference numeral. A reference numeral in the text without a following letter, such as “110,” refers to any or all of the elements in the figures bearing that reference numeral (e.g. “110” in the text refers to reference numerals “110a,” “110b,”and/or “110n” in the figures).

The system architecture 100 (also referred to as “system” herein) includes online virtual experience server 102, data store 120, client devices 110a, 110b, and 110n (generally referred to as “client device(s) 110” herein), and developer devices 130a and 130n (generally referred to as “developer device(s) 130” herein). Virtual experience server 102, data store 120, client devices 110, and developer devices 130 are coupled via network 122. In some implementations, client device(s) 110 and developer device(s) 130 may refer to the same or same type of device.

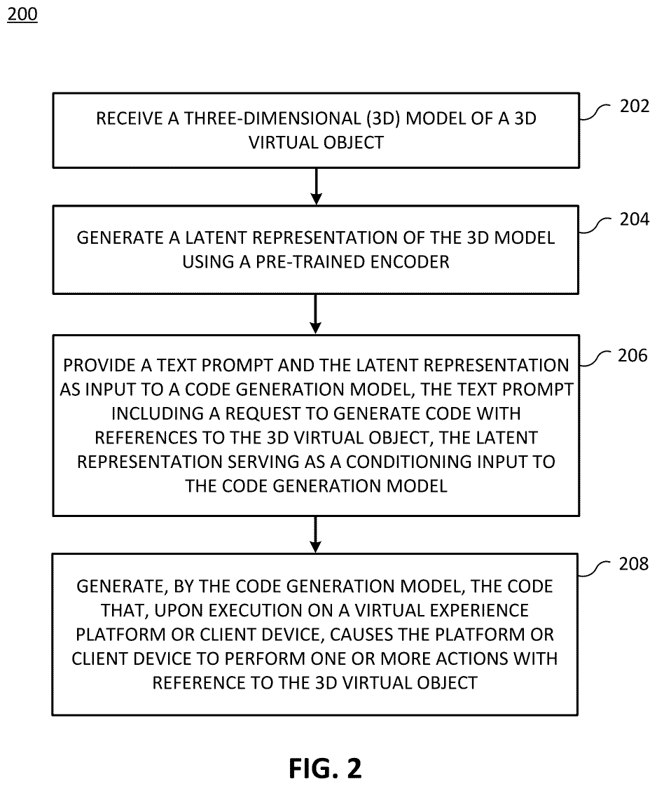

Online virtual experience server 102 can include, among other things, a virtual experience engine 104, one or more virtual experiences 106, and graphics engine 108. In some implementations, the graphics engine 108 may be a system, application, or module that permits the online virtual experience server 102 to provide graphics and animation capability. In some implementations, the graphics engine 108 may perform one or more of the operations described below in connection with the flowchart shown in FIG. 2. In one or more additional or alternative implementations, the operations described below may be performed on one or more client devices 110, or one or more developer devices 130. In some implementations, where the operations are performed depends at least in part on computational resources, e.g., memory, processing power, or disk space. A client device 110 can include a virtual experience application 112, and input/output (I/O) interfaces 114 (e.g., input/output devices). The input/output devices can include one or more of a microphone, speakers, headphones, display device, mouse, keyboard, game controller, touchscreen, virtual reality consoles, etc.

A developer device 130 can include a virtual experience application 132, and input/output (I/O) interfaces 134 (e.g., input/output devices). The input/output devices can include one or more of a microphone, speakers, headphones, display device, mouse, keyboard, game controller, touchscreen, virtual reality consoles, etc.

System architecture 100 is provided for illustration. In different implementations, the system architecture 100 may include the same, fewer, more, or different elements configured in the same or different manner as that shown in FIG. 1.

In some implementations, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a 5G network, a Long Term Evolution (LTE) network, etc.), routers, hubs, switches, server computers, or a combination thereof.

In some implementations, the data store 120 may be a non-transitory computer readable memory (e.g., random access memory), a cache, a drive (e.g., a hard drive), a flash drive, a database system, or another type of component or device capable of storing data. The data store 120 may include multiple storage components (e.g., multiple drives or multiple databases) that may span multiple computing devices (e.g., multiple server computers). In some implementations, data store 120 may include cloud-based storage.

In some implementations, the online virtual experience server 102 can include a server having one or more computing devices (e.g., a cloud computing system, a rackmount server, a server computer, cluster of physical servers, etc.). In some implementations, the online virtual experience server 102 may be an independent system, may include multiple servers, or be part of another system or server.

In some implementations, the online virtual experience server 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience server 102 and to provide a user with access to online virtual experience server 102. The online virtual experience server 102 may include a website (e.g., a web page) or application back-end software that may be used to provide a user with access to content provided by online virtual experience server 102. For example, users may access online virtual experience server 102 using the virtual experience application 112 on client devices 110.

In some implementations, virtual experience session data are generated via online virtual experience server 102, virtual experience application 112, and/or virtual experience application 132, and are stored in data store 120. With permission from virtual experience participants, virtual experience session data may include associated metadata, e.g., virtual experience identifier(s); device data associated with the participant(s); demographic information of the participant(s); virtual experience session identifier(s); chat transcripts; session start time, session end time, and session duration for each participant; relative locations of participant avatar(s) within a virtual experience environment; purchase(s) within the virtual experience by one or more participants(s); accessories utilized by participants; etc.

In some implementations, online virtual experience server 102 may be a type of social network providing connections between users or a type of user-generated content system that enables users (e.g., end-users or consumers) to communicate with other users on the online virtual experience server 102, where the communication may include voice chat (e.g., synchronous and/or asynchronous voice communication), video chat (e.g., synchronous and/or asynchronous video communication), or text chat (e.g., 1:1 and/or N:N synchronous and/or asynchronous text-based communication). A record of some or all user communications may be stored in data store 120 or within virtual experiences 106. The data store 120 may be utilized to store chat transcripts (text, audio, images, etc.) exchanged between participants.

In some implementations of the disclosure, a “user” may be represented as a single individual. Other implementations of the disclosure may include a “user” (e.g., creating user) being an entity controlled by a set of users or an automated source. For example, a set of individual users federated as a community or group in a user-generated content system may be considered a “user.”

In some implementations, online virtual experience server 102 may be or include a virtual gaming server. For example, the gaming server may provide single-player or multiplayer games to a community of users that may access a “system” herein that includes online gaming server 102, data store 120, and client device 110 and/or may interact with virtual experiences using client devices 110 via network 122. In some implementations, virtual experiences (including virtual realms or worlds, virtual games, other computer-simulated environments) may be 2D virtual experiences, 3D virtual experiences (e.g., 3D user-generated virtual experiences), virtual reality (VR) experiences, or augmented reality (AR) experiences, for example. In some implementations, users may participate in interactions (such as gameplay) with other users. In some implementations, a virtual experience may be experienced in near-real-time with other users of the virtual experience.

In some implementations, virtual experience engagement may refer to the interaction of one or more participants using client devices (e.g., 110) within a virtual experience (e.g., 106) or the presentation of the interaction on a display or other output device (e.g., 114) of a client device 110. For example, virtual experience engagement may include interactions with one or more participants within a virtual experience or the presentation of the interactions on a display of a client device.

In some implementations, a virtual experience 106 can include an electronic file that can be executed or loaded using software, firmware or hardware configured to present the virtual experience content (e.g., digital media item) to an entity. In some implementations, a virtual experience application 112 may be executed and a virtual experience 106 rendered in connection with a virtual experience engine 104. In some implementations, a virtual experience 106 may have a common set of rules or common goal, and the environment of a virtual experience 106 shares the common set of rules or common goal. In some implementations, different virtual experiences may have different rules or goals from one another.

In some implementations, virtual experiences may have one or more environments (also referred to as “virtual experience environments”, “virtual environments”, or “virtual spaces” herein) where multiple environments may be linked. An example of a virtual environment may be a three-dimensional (3D) environment. The one or more environments of a virtual experience 106 may be collectively referred to as a “world” or “virtual experience world” or “gaming world” or “virtual world” or “virtual space” or “universe” herein. An example of a world may be a 3D world of a virtual experience 106. For example, a user may build a virtual environment that is linked to another virtual environment created by another user. A character (avatar) of the virtual experience may cross the virtual border to enter the adjacent virtual environment.

It may be noted that 3D environments or 3D worlds use graphics that use a three-dimensional representation of geometric data representative of virtual experience content (or at least present virtual experience content to appear as 3D content whether or not 3D representation of geometric data is used). 2D environments or 2D worlds use graphics that use two-dimensional representation of geometric data representative of virtual experience content.

In some implementations, the online virtual experience server 102 can host one or more virtual experiences 106 and can permit users to interact with the virtual experiences 106 using a virtual experience application 112 of client devices 110. Users of the online virtual experience server 102 may play, create, interact with, or build virtual experiences 106, communicate with other users, and/or create and build objects (e.g., also referred to as “item(s)” or “virtual experience objects”or “virtual experience item(s)”herein) of virtual experiences 106.

For example, in generating user-generated virtual items, users may create characters (avatars), decoration for the characters, one or more virtual environments for an interactive virtual experience, or build structures used in a virtual experience 106, among others. In some implementations, users may buy, sell, or trade virtual experience objects, such as in-platform currency (e.g., virtual currency), with other users of the online virtual experience server 102. In some implementations, online virtual experience server 102 may transmit virtual experience content to virtual experience applications (e.g., 112). In some implementations, virtual experience content (also referred to as “content” herein) may refer to any data or software instructions (e.g., virtual experience objects, virtual experience, user information, video, images, commands, media item, etc.) associated with online virtual experience server 102 or virtual experience applications. In some implementations, virtual experience objects (e.g., also referred to as “item(s)” or “objects” or “virtual objects” or “virtual experience item(s)” herein) may refer to objects that are used, created, shared or otherwise depicted in virtual experience applications 106 of the online virtual experience server 102 or virtual experience applications 112 of the client devices 110. For example, virtual experience objects may include a part, model, character, accessories, tools, weapons, clothing, buildings, vehicles, currency, flora, fauna, components of the aforementioned (e.g., windows of a building), and so forth.

It may be noted that the online virtual experience server 102 hosting virtual experiences 106, is provided for purposes of illustration. In some implementations, online virtual experience server 102 may host one or more media items that can include communication messages from one user to one or more other users. With user permission and express user consent, the online virtual experience server 102 may analyze chat transcripts data to improve the virtual experience platform. Media items can include, but are not limited to, digital video, digital movies, digital photos, digital music, audio content, melodies, website content, social media updates, electronic books, electronic magazines, digital newspapers, digital audio books, electronic journals, web blogs, real simple syndication (RSS) feeds, electronic comic books, software applications, etc. In some implementations, a media item may be an electronic file that can be executed or loaded using software, firmware or hardware configured to present the digital media item to an entity.

In some implementations, a virtual experience 106 may be associated with a particular user or a particular group of users (e.g., a private virtual experience), or made widely available to users with access to the online virtual experience server 102 (e.g., a public virtual experience). In some implementations, where online virtual experience server 102 associates one or more virtual experiences 106 with a specific user or group of users, online virtual experience server 102 may associate the specific user(s) with a virtual experience 106 using user account information (e.g., a user account identifier such as username and password).

In some implementations, online virtual experience server 102 or client devices 110 may include a virtual experience engine 104 or virtual experience application 112. In some implementations, virtual experience engine 104 may be used for the development or execution of virtual experiences 106. For example, virtual experience engine 104 may include a rendering engine (“renderer”) for 2D, 3D, VR, or AR graphics, a physics engine, a collision detection engine (and collision response), sound engine, scripting functionality, animation engine, artificial intelligence engine, networking functionality, streaming functionality, memory management functionality, threading functionality, scene graph functionality, or video support for cinematics, among other features. The components of the virtual experience engine 104 may generate commands that help compute and render the virtual experience (e.g., rendering commands, collision commands, physics commands, etc.) In some implementations, virtual experience applications 112 of client devices 110, respectively, may work independently, in collaboration with virtual experience engine 104 of online virtual experience server 102, or a combination of both.

In some implementations, both the online virtual experience server 102 and client devices 110 may execute a virtual experience engine (104 and 112, respectively). The online virtual experience server 102 using virtual experience engine 104 may perform some or all the virtual experience engine functions (e.g., generate physics commands, rendering commands, etc.), or offload some or all the virtual experience engine functions to virtual experience engine 104 of client device 110. In some implementations, each virtual experience 106 may have a different ratio between the virtual experience engine functions that are performed on the online virtual experience server 102 and the virtual experience engine functions that are performed on the client devices 110. For example, the virtual experience engine 104 of the online virtual experience server 102 may be used to generate physics commands in cases where there is a collision between at least two virtual experience objects, while the additional virtual experience engine functionality (e.g., generate rendering commands) may be offloaded to the client device 110. In some implementations, the ratio of virtual experience engine functions performed on the online virtual experience server 102 and client device 110 may be changed (e.g., dynamically) based on virtual experience engagement conditions. For example, if the number of users engaging in a particular virtual experience 106 meets a threshold number, the online virtual experience server 102 may perform one or more virtual experience engine functions that were previously performed by the client devices 110.

For example, users may be playing a virtual experience 106 on client devices 110, and may send control instructions (e.g., user inputs, such as right, left, up, down, user election, or character position and velocity information, etc.) to the online virtual experience server 102. Subsequent to receiving control instructions from the client devices 110, the online virtual experience server 102 may send experience instructions (e.g., position and velocity information of the characters participating in the group experience or commands, such as rendering commands, collision commands, etc.) to the client devices 110 based on control instructions. For example, the online virtual experience server 102 may perform one or more logical operations (e.g., using virtual experience engine 104) on the control instructions to generate experience instruction(s) for the client devices 110. In other instances, online virtual experience server 102 may pass one or more or the control instructions from one client device 110 to other client devices (e.g., from client device 110a to client device 110b) participating in the virtual experience 106. The client devices 110 may use the experience instructions and render the virtual experience for presentation on the displays of client devices 110.

In some implementations, the control instructions may refer to instructions that are indicative of actions of a character (i.e., avatar) of the user within the virtual experience. For example, control instructions may include user input to control action within the experience, such as right, left, up, down, user selection, gyroscope position and orientation data, force sensor data, etc. The control instructions may include character position and velocity information. In some implementations, the control instructions are sent directly to the online virtual experience server 102. In other implementations, the control instructions may be sent from a client device 110 to another client device (e.g., from client device 110b to client device 110n), where the other client device generates experience instructions using the local virtual experience engine 104. The control instructions may include instructions to play a voice communication message or other sounds from another user on an audio device (e.g., speakers, headphones, etc.), for example voice communications or other sounds generated using the audio spatialization techniques as described herein.

In some implementations, experience instructions may refer to instructions that enable a client device 110 to render a virtual experience, such as a multiparticipant virtual experience. The experience instructions may include one or more of user input (e.g., control instructions), character position and velocity information, or commands (e.g., physics commands, rendering commands, collision commands, etc.).

In some implementations, characters (or virtual experience objects generally) are constructed from components, one or more of which may be selected by the user, that automatically join together to aid the user in editing.

In some implementations, a character is implemented as a 3D model and includes a surface representation used to draw the character (also known as a skin or mesh) and a hierarchical set of interconnected bones (also known as a skeleton or rig). The rig may be utilized to animate the character and to simulate motion and action by the character. The 3D model may be represented as a data structure, and one or more parameters of the data structure may be modified to change various properties of the character, e.g., dimensions (height, width, girth, etc.); body type; movement style; number/type of body parts; proportion (e.g., shoulder and hip ratio); head size; etc.

One or more characters (also referred to as an “avatar” or “model” herein) may be associated with a user where the user may control the character to enable an interaction of the user with the virtual experience 106.

In some implementations, a character may include components such as body parts (e.g., hair, arms, legs, etc.) and accessories (e.g., t-shirt, glasses, decorative images, tools, etc.). In some implementations, body parts of characters that are customizable include head type, body part types (arms, legs, torso, and hands), face types, hair types, and skin types, among others. In some implementations, the accessories that are customizable include clothing (e.g., shirts, pants, hats, shoes, glasses, etc.), weapons, or other tools.

In some implementations, for some asset types, e.g., shirts, pants, etc. the online virtual experience platform may provide users access to simplified 3D virtual object models that are represented by a mesh of a low polygon count, e.g., between about 20 and about 30 polygons.

In some implementations, the user may control the scale (e.g., height, width, or depth) of a character or the scale of components of a character. In some implementations, the user may control the proportions of a character (e.g., blocky, anatomical, etc.). It may be noted that in some implementations, a character may not include a character virtual experience object (e.g., body parts, etc.) but the user may control the character (without the character virtual experience object) to enable the interaction of the user with the virtual experience (e.g., a puzzle game where there is no rendered character game object, but the user still controls a character to control in-game action).

In some implementations, a component, such as a body part, may be a primitive geometrical shape such as a block, a cylinder, a sphere, etc., or some other primitive shape such as a wedge, a torus, a tube, a channel, etc. In some implementations, a creator module may publish a character of a user for view or use by other users of the online virtual experience server 102. In some implementations, creating, modifying, or customizing characters, other virtual experience objects, virtual experiences 106, or virtual experience environments may be performed by a user using an I/O interface (e.g., developer interface) and with or without scripting (or with or without an application programming interface (API)). It may be noted that for purposes of illustration, characters are described as having a humanoid form. It may further be noted that characters may have any form such as a vehicle, animal, animate or inanimate object, or other creative form.

In some implementations, the online virtual experience server 102 may store characters created by users in the data store 120. In some implementations, the online virtual experience server 102 maintains a character catalog and virtual experience catalog that may be presented to users. In some implementations, the virtual experience catalog includes images of virtual experiences stored on the online virtual experience server 102. In addition, a user may select a character (e.g., a character created by the user or other user) from the character catalog to participate in the chosen virtual experience. The character catalog includes images of characters stored on the online virtual experience server 102. In some implementations, one or more of the characters in the character catalog may have been created or customized by the user. In some implementations, the chosen character may have character settings defining one or more of the components of the character.

In some implementations, a character of a user can include a configuration of components, where the configuration and appearance of components and more generally the appearance of the character may be defined by character settings. In some implementations, the character settings of a character of a user may at least in part be chosen by the user. In other implementations, a user may choose a character with default character settings or character setting chosen by other users. For example, a user may choose a default character from a character catalog that has predefined character settings, and the user may further customize the default character by changing some of the character settings (e.g., adding a shirt with a customized logo). The character settings may be associated with a particular character by the online virtual experience server 102.

In some implementations, the client device(s) 110 may each include computing devices such as personal computers (PCs), mobile devices (e.g., laptops, mobile phones, smart phones, tablet computers, or netbook computers), network-connected televisions, gaming consoles, etc. In some implementations, a client device 110 may be referred to as a “user device.” In some implementations, one or more client devices 110 may connect to the online virtual experience server 102 at any given moment. It may be noted that the number of client devices 110 is provided as illustration. In some implementations, any number of client devices 110 may be used.

In some implementations, each client device 110 may include an instance of the virtual experience application 112, respectively. In one implementation, the virtual experience application 112 may permit users to use and interact with online virtual experience server 102, such as control a virtual character in a virtual experience hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual experience, etc.) served by a web server. In another example, the virtual experience application may be a native application (e.g., a mobile application, app, virtual experience program, or a gaming program) that is installed and executes local to client device 110 and enables users to interact with online virtual experience server 102. The virtual experience application may render, display, or present the content (e.g., a web page, a media viewer) to a user. In an implementation, the virtual experience application may include an embedded media player (e.g., a Flash® or HTML5 player) that is embedded in a web page.

According to aspects of the disclosure, the virtual experience application may be an online virtual experience server application for users to build, create, edit, and upload content to the online virtual experience server 102 as well as interact with online virtual experience server 102 (e.g., engage in virtual experiences 106 hosted by online virtual experience server 102). As such, the virtual experience application may be provided to the client device(s) 110 by the online virtual experience server 102. In another example, the virtual experience application may be an application that is downloaded from a server.

In some implementations, each developer device 130 may include an instance of the virtual experience application 132, respectively. In one implementation, the virtual experience application 132 may permit a developer user(s) to use and interact with online virtual experience server 102, such as control a virtual character in a virtual experience hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual experience, etc.) served by a web server. In another example, the virtual experience application may be a native application (e.g., a mobile application, app, virtual experience program, or a gaming program) that is installed and executes local to client device 110 and enables users to interact with online virtual experience server 102. The virtual experience application may render, display, or present the content (e.g., a web page, a media viewer) to a user. In an implementation, the virtual experience application may include an embedded media player (e.g., a Flash® or HTML5 player) that is embedded in a web page.

According to aspects of the disclosure, the virtual experience application 132 may be an online virtual experience server application for users to build, create, edit, and upload content to the online virtual experience server 102 as well as interact with online virtual experience server 102 (e.g., provide and/or engage in virtual experiences 106 hosted by online virtual experience server 102). As such, the virtual experience application may be provided to the client device(s) 110 by the online virtual experience server 102. In another example, the virtual experience application 132 may be an application that is downloaded from a server. Virtual experience application 132 may be configured to interact with online virtual experience server 102 and obtain access to user credentials, user currency, etc. for one or more virtual experiences 106 developed, hosted, or provided by a virtual experience developer.

In some implementations, a user may login to online virtual experience server 102 via the virtual experience application. The user may access a user account by providing user account information (e.g., username and password) where the user account is associated with one or more characters available to participate in one or more virtual experiences 106 of online virtual experience server 102. In some implementations, with credentials, a virtual experience developer may obtain access to virtual experience virtual objects, such as in-platform currency (e.g., virtual currency), avatars, special powers, accessories, which are owned by or associated with other users.

In general, functions described in one implementation as being performed by the online virtual experience server 102 can be performed by the client device(s) 110, or a server, in other implementations if appropriate. In addition, the functionality attributed to a particular component can be performed by different or multiple components operating together. The online virtual experience server 102 can be accessed as a service provided to other systems or devices through suitable application programming interfaces (hereinafter “APIs”), and thus is not limited to use in websites.

### Generating Code Based on 3D Virtual Assets

FIG. 2 is a flow diagram illustrating an example method 200 to generate code based on 3D virtual assets using an AI approach, in accordance with some implementations. In various implementations, the blocks shown in FIG. 2 and described below may be performed by any of the computing devices illustrated in FIG. 1, e.g., one or more of client devices 110 and/or online virtual experience server 102. For example, two or more client devices 110 may perform method 200, or at least one client device 110 and online virtual experience server 102 may perform method 200. In some implementations, certain blocks of method 200 may be performed by a client device 110 and other blocks of method 200 may be performed by an online virtual experience server 102. Method 200 begins at block 202.

Some implementations described herein may make use of data associated with 3D virtual objects or user-submitted code prompts, such as metadata describing the object, script file names, or structural features of user-generated content within a virtual platform. In such cases, data is collected and analyzed only with user permission and in compliance with applicable data protection laws. Identifiable user information is not used in training the models that encode 3D representations or generate code. Data is stored for a limited duration consistent with its intended technical purpose. Users are provided with controls to access data sharing settings, including the ability to opt out of data collection, restrict use for model training, and request deletion of previously uploaded assets or prompts.

At block 202, a 3D model of a 3D virtual object is received. As used herein, a 3D virtual object includes a digitally encoded representation of an object that is intended to be rendered and interacted with within a three-dimensional digital environment, such as, e.g., a virtual experience, simulation, game, or modeling platform. The 3D virtual object may represent any digital asset with a defined spatial structure, including but not limited to, e.g., hats, tools, furniture, terrain features, buildings, vehicles, or accessories used by avatars within a virtual platform.

A 3D model includes one or more data structures representing the geometric, topological, and visual properties of the 3D virtual object. The 3D model may include, e.g., vertex data, polygonal mesh data, texture coordinates, material definitions, skeletal rigging information, and related metadata. In some implementations, the 3D model is represented as a polygon mesh includes a set of vertices, edges, and faces that define the shape of the 3D virtual object in a Cartesian coordinate system. Additional components such as normal vectors, UV maps (where UV refers to vector dimensions), and shading attributes may be associated with the mesh.

In some implementations, the 3D model may be provided in any suitable data format, including but not limited to proprietary platform-specific formats. In various implementations, the model may be received from a user device, a network-accessible asset library, or a remote content storage system associated with a virtual experience platform. In some implementations, the 3D model is received as a component of a bundled asset package that includes associated metadata and source files for scripts, textures, or animations.

In some implementations, the 3D model may be associated with one or more identifiers or metadata values indicating its usage context. For example, the model may be labeled as an avatar accessory, and may include a slot designation such as head, torso, or back. Other metadata fields may include, e.g., creator identifiers, licensing tags, timestamps, and configuration parameters for in-platform behavior (e.g., attachment points, bounding boxes).

In some implementations, the 3D model may include geometric detail at varying levels of resolution. Some models may consist of high-polygon meshes used for in-depth visualization, while others may utilize low-polygon meshes optimized for real-time rendering. The incoming 3D model may be subjected to preprocessing operations including mesh simplification, alignment normalization, or voxelization depending on the downstream requirements of the encoder architecture. In some cases, the model is normalized to a canonical coordinate space, such as centering the object at the origin and rescaling to fit within a unit bounding box.

In some implementations, multiview representations of the 3D model may be generated at or following the time of receipt. For example, a rasterization pipeline may be applied to generate two-dimensional projections of the model from multiple camera angles (e.g., front, side, top, and back views), which may be used as inputs to certain encoder types. The projections may be rendered using fixed lighting conditions and camera parameters to standardize input conditions across models. Block 202 is followed by block 204.

At block 204, a latent representation of the 3D model is generated using a pre-trained encoder, where the latent representation of the 3D model encodes semantic and structural information of the 3D model. A latent representation includes a vectorized or tensor-based encoding of input data that captures abstract features derived from the input, such as, e.g., geometric, structural, and semantic attributes. The representations are generated in a feature space that is distinct from the original format of the input data and are used to convey high-level or compressed information suitable for downstream processing, including code generation or classification tasks.

The encoder used to generate the latent representation is pre-trained. As used herein, a pre-trained encoder includes a machine-learned model or neural network that has been trained prior to deployment on a task-specific dataset, such as reconstructing 3D objects or classifying object types based on their 3D geometry. In various implementations, the encoder may be trained using supervised, unsupervised, or self-supervised learning objectives. In some implementations, the training dataset consists of synthetic or real-world 3D objects, each represented by one or more mesh files, point clouds, or rendered images, along with labels or auxiliary targets.

In some implementations, the encoder may operate on different representations of the 3D model, including, e.g., mesh-based, point cloud-based, or multiview image-based formats. In a mesh-based implementation, the encoder receives as input a structured array of vertex coordinates, face indices, and optional features such as surface normals or color attributes. In a multiview-based implementation, the encoder receives a fixed number of rendered 2D images of the 3D object captured from different viewing angles. In either case, the encoder analyzes the input and outputs a fixed-length vector or tensor that constitutes the latent representation.

In some implementations, the latent representation encodes both semantic and structural information of the 3D model. Structural information may include spatial features such as, e.g., shape contours, topology, surface continuity, and volumetric occupancy. Semantic information may include inferred object class (e.g., “hat”, “chair”, “weapon”), part segmentation (e.g., brim vs. crown in a hat), or affordances (e.g., graspable, wearable, attachable). The encoder model may be trained to produce latent vectors that are clustered or separated in feature space based on such semantic and structural characteristics.

In some implementations, the dimensionality and format of the latent representation depend on the architecture of the encoder. For example, the output may be a single global feature vector of fixed dimension (e.g., 1024 or 2048 float32 values), or a sequence of tokens or patch embeddings derived from localized spatial regions of the input. In some implementations, the encoder produces an intermediate latent space prior to further transformation or pooling operations, such as linear projection, self-attention, or learned resampling modules. The operations may be applied to reduce or reshape the latent representation to match the expected input format of the downstream decoder.

In some implementations, generating the latent representation of the 3D model using the pre-trained encoder includes providing a number of images depicting respective views of the 3D model to the pre-trained encoder, where the latent representation of the 3D model is based on the number of images. In some implementations, the images may be rendered from the 3D model using a virtual camera positioned at various locations relative to the object, such as fixed angles along a sphere or hemisphere centered on the object. For example, the selected views may cover front, back, top, bottom, left, right, and oblique perspectives to provide the encoder with a comprehensive representation of the surface geometry and appearance of the 3D model.

In some implementations, each image is transformed into a tensor format compatible with the input requirements of the encoder. The images may be stacked or independently encoded depending on the architecture of the encoder. In encoders designed to analyze sequences or sets of images, the encoder may fuse features across views using attention mechanisms, convolutional layers, or pooling operations. The fused result is a latent representation that reflects aggregated semantic and structural features extracted from the multiple viewpoints. For example, the representation may capture object symmetry, protrusions, surface curvature, or spatial configurations that are not evident from any single view. Block 204 is followed by block 206.

At block 206, a text prompt and the latent representation of the 3D model are provided as input to a code generation model, where the text prompt includes a request to generate code with references to the 3D object, and where the latent representation of the 3D model serves as a conditioning input to the code generation model. As used herein, a code generation model includes a machine-learned model, such as, e.g., a transformer-based language model, trained to generate computer program code from natural language inputs or other conditioning inputs. In some implementations, the code generation model may support multiple programming languages. In some implementations, the code generation model may be pre-trained on a corpus of source code and fine-tuned on context-specific tasks, such as generating platform-specific APIs or behavior scripts associated with 3D assets.

In some implementations, the text prompt includes a request to generate code and may include one or more tokens identifying the intended behavior or use case for the code. Example prompts include “script to attach hat to player avatar,” “create click event for object,” or “script for rotating platform animation.” In some implementations, the text prompt may include structured elements, such as the file path or module name where the code is to be inserted, or tags indicating code length, formatting, or constraints. In some implementations, the prompt may include additional context such as, e.g., function headers, partial code blocks, or comments.

In some implementations, the text prompt is tokenized and embedded using a text embedding module, and the resulting embeddings are concatenated or otherwise combined with the latent representation of the 3D model. In sequence-based architectures, the latent representation may be prepended to the text tokens to form a prefix. In encoder-decoder or decoder-only code generation models, the combined sequence is passed through a transformer stack to predict subsequent tokens corresponding to source code. In some implementations, the code generation model uses attention mechanisms to relate the latent 3D features and the text prompt during code generation.

The latent representation of the 3D model serves as a conditioning input, influencing the content and structure of the generated code. For example, if the 3D model corresponds to a hat, the latent features may indicate shape, orientation, and attachment points, which can guide the generation of attachment-related code. The conditioning effect may be realized via cross-attention, prefix-tuning, adapter modules, or prompt injection, depending on the architecture of the code generation model. In some implementations, the code generation model parameters are trained or fine-tuned to associate particular latent 3D features with specific code templates, behaviors, or API calls relevant to the platform.

In some implementations, the code generation model is trained by providing embeddings derived from multiview images of a number of prior 3D models. The multiview images are rendered by capturing each 3D model from several distinct viewpoints, using virtual cameras placed at predefined spatial positions relative to the object. The captured images are passed through a pre-trained encoder, such as a vision-based encoder configured to analyze sets of 2D images, to produce feature embeddings. Each embedding corresponds to a compact vector representation that captures both semantic and structural aspects of the underlying 3D model, as inferred from the multiview inputs.

In some implementations, during training, the code generation model receives, as input, pairs consisting of a 3D model embedding and an associated text prompt or code snippet that is relevant to the 3D model. For example, a training example may include an embedding corresponding to a 3D model of a chair and a target output comprising Lua code that defines how the chair object is to be positioned or interacted with in a virtual environment. The code generation model is trained to minimize a loss function that reflects the difference between its generated output and the reference code provided in the training data. Over time, this enables the code generation model to associate patterns in the 3D feature embeddings with code structures and programming constructs that are semantically and contextually relevant to those patterns.

In some implementations, the training dataset may include a diverse collection of 3D models representing different object categories, geometries, and intended functions within a virtual environment. The diversity helps the code generation model generalize across input embeddings derived from previously unseen 3D objects. By conditioning on embeddings obtained from multiview-derived representations, the code generation model is trained to incorporate spatial and geometric context into the generated code, aligning the code semantics with the structural and visual properties of the source 3D model.

In some implementations, each embedding of the embeddings derived from the multiview images is paired with corresponding script data, and training the code generation model includes performing supervised learning based on the embeddings and the corresponding script data. The script data may include programming code that define behaviors, transformations, or other attributes associated with the 3D model in a virtual experience platform. The scripts may include, e.g., function definitions, object property assignments, event handlers, and other code elements that reference or manipulate the corresponding 3D model.

During supervised training, each training example includes both an embedding that encodes semantic and structural features of a 3D model, and a target script that serves as the ground truth output for the code generation model to be trained on. The code generation model is trained to minimize a loss function that penalizes differences between the predicted code sequence and the reference script, based on token-level comparisons such as cross-entropy loss. Over multiple training iterations, the model parameters are updated to improve the alignment between embedding features and the resulting code sequences.

In some implementations, the code generation model is trained by providing embeddings derived from multiview images of a number of prior 3D models, where the code generation model includes a pre-trained transformer and where the training include fine-tuning the transformer. As used herein, a transformer model includes a neural network architecture that utilizes self-attention mechanisms to analyze input sequences and generate corresponding outputs. Pre-training of the transformer may be conducted on a large corpus of code sequences unrelated to 3D models to establish general-purpose programming language understanding.

In some implementations, the embeddings used for fine-tuning are obtained by analyzing multiview images of respective 3D models using a separate encoder. Each embedding captures features that represent structural and semantic characteristics of the associated 3D model. The embeddings are paired with corresponding reference code sequences to form training examples. The embeddings serve as conditioning inputs to the transformer, while the code sequences are used as target outputs for the supervised learning task.

In some implementations, prior to providing the latent representation of the 3D model as input to the code generation model, the latent representation is compressed. As used herein. compression includes reducing the dimensionality or token length of the latent representation while retaining information relevant to downstream code generation.

In some implementations, the compression can be performed using a learnable projection mechanism, such as, e.g., a trainable pooling module or dimensionality-reducing encoder layer. For example, a set of latent vectors output by a pre-trained encoder may be aggregated into a smaller set of compressed tokens using cross-attention, mean pooling, or a gated selection mechanism. The number of compressed tokens may be fixed regardless of the input size, enabling consistent input dimensions across varying 3D models and encoder outputs.

In some implementations, compressing the latent representation is performed by a perceiver module that implements a learned pooling mechanism. As used herein, a perceiver module includes a neural network component that accepts a variable number of input tokens and maps them to a fixed-length output sequence using attention-based transformations.

In some implementations, the learned pooling mechanism within the perceiver module operates by initializing a fixed set of latent queries that attend over the encoder outputs via cross-attention. During training, the parameters of the queries are optimized to select and aggregate the most relevant information from the encoder-derived latent vectors. In some implementations, the perceiver module may be trained jointly with the downstream code generation model or independently in a pretraining stage. The cross-attention operation enables the perceiver to adaptively focus on different parts of the input representation depending on the context and structure of the 3D model. Block 206 is followed by block 208.

At block 208, code is generated by the code generation model that, upon execution on a virtual experience platform or a client device, causes the virtual experience platform or the client device to perform one or more actions with reference to the 3D virtual object. The code generation model receives at least the following inputs: a text prompt that defines the desired behavior or output, and a latent representation of the 3D model that encodes semantic and structural information of the corresponding virtual object. The text prompt is tokenized and converted into a sequence of embedding vectors. The latent representation is provided as an additional input that influences the token prediction during generation.

As used herein, the term conditioning input includes data supplied to the code generation model that alters or constrains the output distribution during inference. In this case, the latent representation of the 3D model serves as a conditioning input by influencing the attention weights and hidden states within the transformer layers of the code generation model. The conditioning modifies the parameters or weights of the code generation model to bias the output toward code that corresponds to the structure, attributes, or intended use of the associated 3D virtual object.

In some implementations, the latent representation may be provided to the code generation model as a prefix, prepended to the tokenized text prompt, or incorporated using attention mechanisms such as cross-attention. In decoder-only transformer architectures, the latent vectors may be prepended to the sequence of embeddings, thereby influencing all subsequent token predictions. In encoder-decoder architectures, the latent representation may be input to the encoder while the decoder generates tokens based on encoder outputs and autoregressive decoding.

In some implementations, the generated code comprises a sequence of tokens in a programming language format. Each token is selected from a predefined vocabulary using sampling or decoding methods applied to the output logits of the code generation model. The code generation model iteratively produces tokens based on prior context, updating its internal state at each operation.

In some implementations, the generated code is influenced by the latent features in a manner that enables referencing or manipulation of the original 3D model. For example, if the latent representation encodes that the object is a wearable accessory, the code generation model may generate code that attaches the object to a body joint of the avatar, invokes platform APIs for accessory registration, or sets visibility and collision parameters.

In some implementations, once generated, the code may be converted from tokens to human-readable text by a transformer decoder. The resulting code string may be logged, stored, or passed to a deployment system for use within a virtual experience platform. In some implementations, the generated code is combined with metadata including the original prompt and identifier of the associated 3D object.

In some implementations, the code is in a scripting language, and is stored in association with the 3D model of the 3D virtual object, where the 3D virtual object is loaded into a virtual experience running on the virtual experience platform or the client device, and where the code is available for execution in response to one or more events that take place in the virtual experience. For example, when the virtual experience is hosted on a platform that supports Lua, the generated code may be formatted as a Lua script. The scripting language enables dynamic behavior, event-driven execution, and interaction logic to be encoded in a manner that integrates with the runtime environment of the platform.

In some implementations, the generated code is stored in association with the 3D model of the 3D virtual object. The association may be realized by embedding the code within metadata fields of the asset, storing the code in a linked resource that is co-located with the code generation model in a content repository, or maintaining a reference to the code in a platform-specific asset management system. The stored code is intended to be retrievable whenever the corresponding 3D virtual object is instantiated or rendered in a virtual experience.

In some implementations, when the 3D virtual object is loaded into a virtual experience, the associated code is made available for execution. The execution of the code may be triggered by one or more events that occur during the runtime of the experience. The events can include, e.g., user interactions (e.g., avatar collision, selection, or attachment), environmental changes (e.g., lighting updates, proximity triggers), or scripted sequences initiated by other components in the experience.

In some implementations, the code generated by the code generation model corresponds to a script that defines how the three-dimensional virtual object behaves within a virtual experience. The generated code may specify object-level actions such as movement, rotation, deformation, or attachment to another object or avatar. For example, the code may cause a virtual hat to attach to a head of an avatar, a lever to rotate when pulled, or a vehicle model to move forward along a defined path. The same script may also define physics-based behaviors, such as a lightweight object being displaced when struck or a suspended object swinging in response to gravity or collision.

In some implementations, the code further defines changes in the appearance or state of the three-dimensional virtual object in response to user interaction or simulated environmental conditions. For example, the code may animate a door opening when a handle is clicked, simulate a cardboard box collapsing when a heavy item falls on it, or alter the surface of an object to appear wet when exposed to simulated rain. Other examples include generating a glowing effect when an object is activated, causing particles to emit upon impact, or triggering sound playback when an object is touched. The code thereby governs dynamic behaviors that make the three-dimensional virtual object responsive within the virtual environment.

In some implementations, the one or more actions generated by the code include modifying a physical property of the three-dimensional virtual object based on simulated interactions within the virtual environment. The code generated by the code generation model may reference operations such as applying forces, responding to collisions, or adjusting constraints that affect the object's simulated mass, elasticity, momentum, or other physical attributes. For example, the generated code may specify a change in mass distribution of a virtual car model upon impact with another object or initiate a dynamic change in surface friction in response to terrain variation. These modifications may be handled by a physics engine integrated within the virtual experience platform or client device runtime environment. The underlying simulation parameters are determined either directly by the code or indirectly through function calls or API hooks to the platform's physical simulation layer.

In some implementations, the one or more actions generated by the code include changing a visual, spatial, or behavioral attribute of the three-dimensional virtual object in response to input from an avatar or a system event. The visual attribute changes may include altering material properties such as color, transparency, or texture mapping in response to user interactions. Spatial changes may include repositioning or reorienting the object in the 3D environment, such as moving a door to an open state when approached by an avatar. Behavioral changes may involve triggering animation states, logic transitions, or scripted routines, such as making a virtual pet avatar exhibit predefined gestures when interacted with. The code generated by the code generation model may include conditional logic, event listeners, or state machines that respond to runtime events, avatar proximity, gesture recognition, or pre-specified triggers within the environment.

In some implementations, one or more of blocks 202-208 may be performed by one or more server devices, and one or more of blocks 202-208 may be performed by one or more client devices. In some implementations, all of method 200 may be performed by a server device, or by a client device.

In various implementations, the techniques described herein may include combinations of one or more features recited in the claims. For example, in some implementations, a computer-implemented method includes: receiving a three-dimensional (3D) model of a 3D virtual object; generating a latent representation of the 3D model using a pre-trained encoder, wherein the latent representation of the 3D model encodes semantic and structural information of the 3D model; providing a text prompt and the latent representation of the 3D model as input to a code generation model, wherein the text prompt comprises a request to generate code with references to the 3D virtual object and wherein the latent representation of the 3D model serves as a conditioning input to the code generation model; and generating, by the code generation model, the code that, upon execution on a virtual experience platform or a client device, causes the virtual experience platform or the client device to perform one or more actions with reference to the 3D virtual object.

In some implementations, generating the latent representation of the 3D model using the pre-trained encoder includes providing a plurality of images depicting respective views of the 3D model to the pre-trained encoder, wherein the latent representation of the 3D model is based on the plurality of images. In some implementations, the method may further include training the code generation model by providing embeddings derived from multiview images of a plurality of prior 3D models.

In some implementations, each embedding of the embeddings derived from the multiview images is paired with corresponding script data, and training the code generation model includes performing supervised learning based on the embeddings and the corresponding script data. In some implementations, training the code generation model includes providing embeddings derived from multiview images of a plurality of prior 3D models, wherein the code generation model includes a pre-trained transformer and wherein the training comprises finetuning the pre-trained transformer.

In some implementations, prior to providing the latent representation of the 3D model as an input to the code generation model, the method further includes compressing the latent representation. In some implementations, compressing the latent representation is performed by a perceiver module that implements a learned pooling mechanism.

In some implementations, the code is in a scripting language, and the method further includes storing the code in association with the 3D model of the 3D virtual object, wherein the 3D virtual object is loaded into a virtual experience running on the virtual experience platform or the client device and wherein the code is available for execution in response to one or more events that take place in the virtual experience.

Various implementations may also include computing systems or non-transitory computer-readable media configured to carry out any of the operations described above. In some implementations, a memory with instructions stored thereon and a processing device, coupled to the memory, are configured to execute the instructions to perform operations including: receiving a three-dimensional (3D) model of a 3D virtual object; generating a latent representation of the 3D model using a pre-trained encoder, wherein the latent representation encodes semantic and structural information of the 3D model; providing a text prompt and the latent representation as input to a code generation model, wherein the text prompt comprises a request to generate code with references to the 3D virtual object and wherein the latent representation serves as a conditioning input to the code generation model; and generating, by the code generation model, the code that, upon execution on a computing device, causes the computing device to perform one or more actions with reference to the 3D virtual object.

In further implementations, the actions include modifying a physical property of the three-dimensional virtual object based on simulated interactions within the virtual environment. In some implementations, the actions include changing a visual, spatial, or behavioral attribute of the three-dimensional virtual object in response to input from an avatar or system event.

Different sub-combinations of the above implementations may be realized in different contexts. For example, an implementation may include: receiving a three-dimensional (3D) model of a 3D virtual object; generating a latent representation using a pre-trained encoder by providing a plurality of images depicting respective views of the 3D model, wherein the latent representation is based on the plurality of images; and training the code generation model by providing embeddings derived from multiview images of a plurality of prior 3D models.

Another implementation may include: receiving a 3D model of a virtual object; generating a latent representation using a pre-trained encoder; compressing the latent representation using a perceiver module that implements a learned pooling mechanism; and providing the compressed representation and a text prompt as input to a code generation model to generate executable code.

In a further example, the method includes receiving a 3D model; generating a latent representation; providing the representation along with a text prompt to a code generation model; generating the code; and storing the code in association with the 3D model of the 3D virtual object, wherein the object is loaded into a virtual experience and the code is available for execution in response to one or more events that take place in the virtual experience.

In another implementation, training the code generation model includes: providing embeddings derived from multiview images of prior 3D models, each embedding paired with corresponding script data; and performing supervised learning based on the embeddings and corresponding script data.

Yet another implementation includes: providing embeddings to a code generation model that includes a pre-trained transformer and performing fine-tuning of the transformer using training data derived from multiview images of 3D models.

These implementations, and others, may be realized in different forms including method, system, and non-transitory computer-readable medium, with components, operations, and data structures as described above. Multiple combinations and sub-combinations of the described features may be applied based on, e.g., the deployment context, training regime, runtime constraints, and target computing environment.

### Architecture for Integrating 3D Virtual Assets Into Code Generation

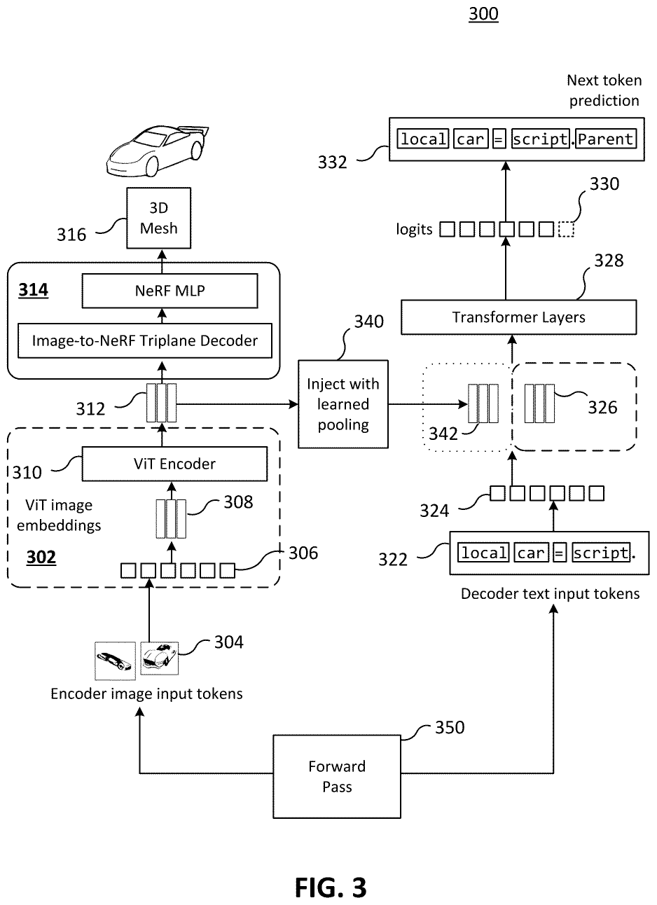

FIG. 3 illustrates an example 300 of an architecture to train a visual encoder to generate a latent representation of features of a 3D object that are usable to generate a 3D mesh for the 3D object and usable as latent feature representations of the 3D object as input to a code generation model. Portions of the architecture 300 can be used to generate code based on one or more images of a 3D object (or other visual information) and text prompt.

In FIG. 3, the box 302 illustrates operation of a visual encoder. Specifically, a plurality of images of a 3D object are tokenized (converted into a set of image input tokens) that are provided as image input tokens 304 to an image encoding layer 306 of an encoder. In the example of FIG. 3, three input images are shown that depict a racecar from different capture angles. In various implementations, different camera angles, positions, perspectives, distance from the object, and other parameters may be used for the input images. The input images are referred to as multiview images, since they are images of an object from multiple viewpoints.

An image encoding layer 306 generates input image embeddings 308—i.e., vision transformer (ViT) image embeddings—from input images, e.g., represented as encoder image input tokens 304. For example, the image embeddings 308 may be a set of vectors obtained by splitting each input image into fixed-size patches and obtaining linear projections of each of the flattened patches (set of patches). In some implementations, the set of vectors may include vectors arranged in a sequence.

The input image embeddings 308 are provided to an image encoder—ViT encoder 310. The ViT encoder 310 is a transformer encoder (e.g., that include a plurality of neural network layers, aka transformer layers) that generates output embeddings 312 by encoding input tokens 308.

The output embeddings 312 are provided to decoder 314 during a training phase. In the illustrated configuration, decoder 314 includes two blocks: an image-to-NeRF triplane decoder and a NeRF-based multi-layer perceptron (MLP), where NeRF refers to a neural radiance field. The decoder 314 reconstructs a 3D mesh 316 corresponding to the 3D object depicted in the input images 304. This reconstructed mesh 316 may consist of a bare geometric mesh or a fully rendered object including texture. The reconstruction supports supervised learning by enabling comparison of rendered images from novel viewpoints against the input images, thereby facilitating backpropagation and refinement of the ViT encoder to produce informative embeddings. During code generation, decoder 314 and mesh 316 are not used. Instead, the trained encoder outputs the embeddings 312, which are passed via connector module 340 to downstream components for generation of structured code representations.

In the example, the encoder 302 is trained using a training objective that optimizes reconstructing a 3D mesh from input images of the 3D object. For example, parameters (weights) of ViT encoder 310 may be adjusted using supervised learning by using a loss value obtained based on a comparison of the output 3D mesh is compared to a known groundtruth 3D mesh of the object. A large number and variety of input objects (and their images) may be used to train the encoder 302 (and specifically, the ViT encoder 310) such that the output embeddings 312 represent features of the object sufficiently to enable decoder 314 to generate a 3D mesh that represents the object accurately.

Further, since the ViT encoder 310 is a multi-layer encoder, latent embeddings are present in the intermediate layers of ViT encoder 310—between an input layer that receives input embeddings 308 and an output layer that outputs the output embeddings 312. The latent embeddings may encode general 3D features of the 3D object, before they are refined into mesh representations. The latent embeddings are used as conditioning input for a code generation model, as further described below. With the use of multiview images of an object as input, the latent embeddings in the middle layers of the ViT encoder 310 may encode general 3D features prior to those features being refined into mesh representations (e.g., by a decoder 314). For example, the embeddings may encode latent features that represent geometric and semantic characteristics of the 3D object.

In FIGS. 3, 322 includes input text tokens, e.g., from a prompt provided to a code generation model, such as a large language model (LLM). The input tokens 322 are encoded into LLM word embeddings 326 by an encoder 324. The word embeddings are input to the transformer layers 328 of the LLM. The transformer layer is tasked with generating code that responds to the prompt. In the illustrated example, the input prompt includes the code “local car =script” This is a code fragment and the task for the LLM (transformer layer 328) is to output tokens that represent the next word in the code.

The task for the LLM in this case is to generate code that can perform one or more operations with reference to a 3D object. For example, if the 3D object is a baseball bat, the operations can be a 3D avatar in a 3D environment gripping the bat by the bat handle, holding the bat, swinging the bat, etc. In another example, if the 3D object is a bottle, the operations can be a 3D avatar in the 3D environment holding the bottle, opening the bottle cap, drinking from the bottle, filling up the bottle, etc. The objective for the LLM is to generate code (automatically) based on valid operations for different types of objects.

In the illustrated example, the 3D object is a car, and the operations to be performed by the generated code can include any operations valid for a car, e.g., starting the car, stopping the car, accelerating/breaking, parking, steering, filling gas, or any other operation that can be performed with reference to a car that is a virtual 3D object in a virtual environment.

Per techniques described herein, conditioning input 342 based on embeddings from the ViT encoder 310, e.g., output embeddings or latent embeddings from one or more intermediate layers of the ViT encoder 310, is provided as conditioning input to transformer layers 328. In some implementations, the conditioning input may server as prefix to the LLM word embeddings 326 during code generation by transformer layers 328, e.g., autoregressive code generation.

In some implementations, to obtain conditioning input 342, latent embeddings from ViT encoder are provided to a perceiver 340. Latent embeddings produced by the encoder are compressed by the perceiver 340 into a smaller latent representation. In some implementations, compression is achieved by learned pooling techniques that select and condense features of the object.

The perceiver is a form of learned pooling that selectively compresses the vector size, such that the conditioning input is a compressed from the embeddings 312.

In the transformer layers, where autoregressive code generation is performed based on the LLM word embeddings 326, the code tokens are concatenated with conditioning input 342 (the output of the perceiver). The conditioning input 342 is a fixed prefix that represents the 3D features of the object.

In the decoder forward pass of the transformer layers, output logits corresponding to the 3D prefix may be ignored and loss may be computed over just the code tokens. In this way, the attention mechanism of the LLM (represented by transformer layers 328) can pull information from the 3D prefix to condition subsequent code tokens. The conditioning guides autoregressive generation of the code with contextual information about the 3D object (e.g., the car).

The transformer outputs logits 330. The logits represent output code 332. In the illustrated example, the LLM has generated a prediction that “Parent” is the appropriate next word after “local car =script.” which was provided in the input 322. Via autoregressive code generation, the transformer can continue to generate additional words, thus producing a snippet of code that can operate on the 3D object (car).

The transformer layers 328 therefore integrate information from both the textual and visual domains. Specifically, the text input prompt and the latent embeddings injected as a prefix enables visual properties of the 3D object to guide the code generation by the transformer layers 328.

Logits 330 correspond to the next token in the set, predicting the next part of the code. The generation is depicted in the figure by the phrase “Next token prediction.” In some implementations, the decoder (of transformer layers 328) may generate the output one token at a time, in an autoregressive manner (e.g., where the preceding output tokens are provided as additional inputs to the code generation model). The logits represent a probability distribution over possible next tokens.

The label 350 illustrates a forward pass (inference pass of the architecture 300). Specifically, the shaded portion illustrates that multiple images of a 3D object are provided as input to a trained encoder 302, and corresponding output embeddings (latent embeddings) 312 are obtained. The output embeddings are analyzed with a perceiver 350 and conditioning input 342 is generated. An input prompt 322 for code generation with reference to the 3D object (that the input images are of) is provided to an LLM. Word embeddings 326 of the input prompt 322 together with conditioning input 342 (used as prefix) are provided to transformer layers 328 which generates logits 330 that represent output tokens 332. In an autoregressive operation, tokens are generated iteratively, with the conditioning input used across iteration. In this manner, architecture 300, by using visual features of the 3D object as conditioning input, enables an LLM to generate output code that takes into account notions such as the shape, geometry, and other attributes of the 3D object. In the forward pass (inference), the decoder 314 is not used; it is used only during the training of encoder 302.

FIG. 3 illustrates multiple different aspects. First, it illustrates the training of encoder 302 to generate embeddings that represent 3D features of a 3D object depicted in multiview images by training the encoder 302 when coupled to decoder 314 that is tasked with generating a 3D mesh for the object. The encoder 302 is thus trained separately from the LLM. The encoder 302, upon being trained, is capable of generate embeddings that represent 3D features of 3D objects that are depicted in multiview images.

Second, it illustrates training of perceiver 340. To train perceiver 340, encoder weights (of encoder 302, and specifically, ViT encoder 310) are frozen. The decoder (transformer layers 328) can be any existing transformer decoder, e.g., that is part of a large language model. The decoder is finetuned to “read” from the encoder representations extracted by the perceiver 340. The perceiver 340, which is responsible for selectively translating information from the encoder outputs 312 to the decoder is trained from scratch. For example, the generated code may be examined and perceiver 340 be adjusted using a loss function.

The split-phase training—where the encoder is trained separately from the finetuning of the decoder and training of the perceiver—avoids loss divergence that can occur when fully training multimodal LLMs, e.g., in this case, the LLM takes visual inputs in the form of conditioning input 342 and text inputs in the form of LLM word embeddings 326.

The training approach enables leveraging pretrained backbones, e.g., encoder 302 can use pre-trained encoders that generate ViT image embeddings 308 from input images 304 and a pretrained ViT encoder (vision transformer) that generates output embeddings. The pretrained backbones are fully replaceable, and can be updated as vision and/or code-generation models are updated. The training data used to train architecture 300 can include a plurality of 3D assets and their corresponding code. Architecture 300 latent representations of features of a 3D dimensional object as prefix to autoregressive code generation.

To enable model training and maintain high accuracy of code generated by the code generation model, in various implementations, the model architecture is implemented such that the encoder and decoder can be trained separately. In some implementations, the encoder is pre-trained on a 3D reconstruction task in which multiple rendered images of a 3D object (such as input tokens 304) are provided to the encoder to generate image embeddings 312. These embeddings are passed through subsequent layers (e.g., the decoder and multilayer perceptron blocks shown at 314) to reconstruct a 3D mesh 316. During this training process, rendered projections of the reconstructed mesh are compared with the original multiview input images at corresponding viewpoints, and the reconstruction loss is minimized such that the rendered views approximate the input images. The resulting encoder weights are thereby trained to encode both semantic and structural aspects of 3D geometry. During the subsequent code generation phase, the encoder remains frozen, providing stable, semantically meaningful embeddings as input. A connector module compresses and transforms these encoder outputs before concatenation with embedded code tokens, forming a fixed-length prefix. The decoder is then trained to generate code tokens based on this combined input. Only the connector and decoder modules are fine-tuned during this second training phase, which improves stability and prevents training collapse associated with simultaneous multimodal optimization.

Some technical advantages of one or more described features include the ability to condition code generation on structured 3D input data, rather than relying solely on text-based prompts. By incorporating a latent representation of a 3D virtual object generated from a pre-trained encoder, the code generation model can produce output that reflects the physical and semantic attributes of the object.

Another technical advantage of some implementations is the decoupling of the 3D encoder and code generation decoder during training. The encoder, which has been pre-trained on a 3D reconstruction task, produces stable and semantically meaningful embeddings that do not include modification during code generation training.

Another technical advantage is the use of a transformation module, i.e., the inject-with-learned-pooling module 340, to adapt the output of the pretrained encoder 302 to the format expected by the decoder. In some implementations, encoder output includes high-dimensional embeddings 342 that reflect structural and semantic properties of a 3D object. These embeddings 342 are transformed by the module 340 into a compressed representation suitable for concatenation with the LLM word embeddings 326, which are generated from decoder text input tokens 322.

The resulting concatenated sequence, comprising object-based embeddings and embedded input code tokens, forms a fixed-length prefix for conditioning the transformer layers 328. This prefix enables the decoder to incorporate context from the 3D object during next-token prediction without disrupting the tokenization or autoregressive generation behavior of the decoder. This conditioning improves alignment between generated code and the underlying object structure and purpose, addressing limitations of conventional code generation models that operate without object-based grounding.

Another technical advantage is high training efficiency, attributable to several factors including separate training of the encoder and decoder, compression of latent representations via a connector module, and reuse of pretrained components. In particular, the encoder is pre-trained on a 3D reconstruction task and remains frozen during code generation, which avoids redundant optimization and stabilizes training. Only the connector and decoder components undergo task-specific fine-tuning, reducing computational cost and expediting adaptation to novel use cases. For example, new asset categories may include unfamiliar 3D object classes such as vehicles, furniture, or toys (e.g., a new type of doll or car), while variations in code styles may involve differences in how transformations, material definitions, or instantiation logic are expressed across different authoring environments or template systems.

Another technical advantage is that the described implementations enable object-specific code generalization across a wide range of virtual assets. The model conditions code generation on the geometry and structure of a given 3D object rather than relying on a fixed class label or identifier. This allows the model to generate tailored code even for previously unseen 3D assets, including new types of virtual objects such as dolls, vehicles, or tools. The architecture separates training responsibilities by reusing pretrained encoder components and only training lightweight connector and decoder layers, which reduces computational cost and facilitates efficient adaptation to new content. In addition, the compressed latent representations support fast inference and minimal resource usage. The described approach supports integration with dynamic asset pipelines and accommodates variability in coding practices (e.g., different script templates, naming conventions, or modularization patterns), allowing broad applicability across virtual content libraries.

### Example 3D Object and Corresponding Code

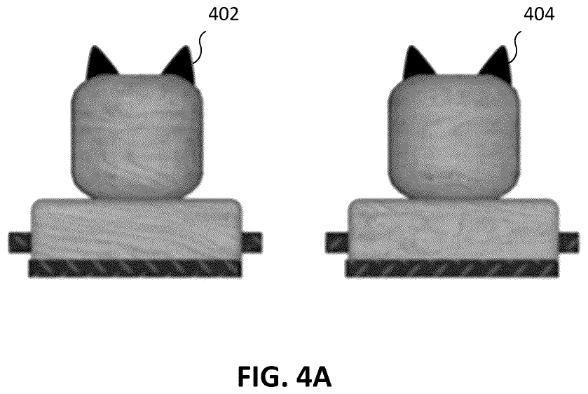

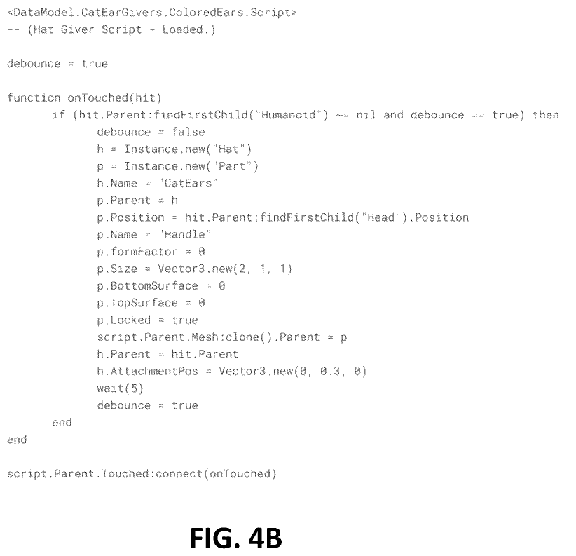

FIG. 4A illustrates an example of a 3D model of an object that is a virtual asset—specifically, a hat accessory—that is input to an encoder (e.g., encoder 302 of architecture 300) to generate a latent representation. The figure illustrates two different views of the same object: a front view 402 of the 3D model, and a back view 404 of the 3D model. The asset itself is a hat accessory that is fittable on the head (or portion thereof) an avatar within a virtual environment. The hat may be associated with various operations, e.g., fitting to the head, rotating, flapping (in the presence of air), being tossed up, being worn or being taken off, doffed, etc. all of which are enabled by corresponding code that can execute on the virtual platform.

In the front view 402, the 3D model has protrusions resembling cat ears or similar structures atop a rounded head-like element. The rounded head sits atop a broader base structure, with textures that suggest a wood-like surface, providing a visual representation of both material properties and structural design. The base is wider than the head, and the texture conveys a distinct pattern, which will be significant in generating a meaningful latent representation. The surface properties, shapes, and relative positioning of the different parts of the 3D model are features that will be captured by the encoder to produce an effective latent embedding. The back view 404 provides additional perspective on the same 3D model. The head structure remains consistent, with the prominent ear components extending upwards, but the view reveals detail regarding the alignment and texture of the rear part of the lower body component.

FIG. 4B presents an example of code that has been generated by the architecture 300 (specifically, transformer layers 328 of an LLM) using the latent embeddings of a 3D virtual asset, building on the representation of the 3D model from FIG. 4A. In this specific scenario, different views of the hat (e.g., the views depicted in FIG. 4A or additional/alternative views) are provided to an encoder (e.g., encoder 302). Additionally, a text prompt is provided (similar to prompt 322) to the transformer. Latent embeddings corresponding to the hat accessory are obtained and are input to perceiver 340 to obtain conditioning input 342. The LLM prompt includes a reference to a script path related to the hat giver functionality. As seen in FIG. 4B, the output code enables the hat to be worn by an avatar on occurrence of the event “touched.” For example, upon detecting that the avatar has touched the 3D hat within a virtual environment, the script of FIG. 4B is executed to automatically place the hat on the head of the avatar. Note that the code portion, including the function “onTouched” is automatically generated by the LLM.

The script includes a reference to the script data model “<DataModel.CatEarGivers.ColoredEars.Script>”, labeled in the comment as a “Hat Giver Script.” The script data model serves as an initialization or identifier for the script, which is to handle the interaction that results in the hat accessory being attached to the avatar. The debounce variable is set to true to control the occurrence of events and prevent multiple rapid triggers of the script, enabling the logic to be executed in a controlled manner.

The main function, named “onTouched(hit),” is triggered when an interaction occurs, such as when an avatar collides with or touches the hat giver object. The function checks if the parent of the hit object has a child named “Humanoid” and whether debounce is true. This enables the interaction to be initiated by an avatar and enables the function to not be called repeatedly within a short time frame. Upon satisfying the conditions, debounce is set to false to prevent reentry while the logic is being executed.

Within the function, the code for the hat accessory is such that it can be worn by an avatar in the virtual environment. A new instance of a hat is created, named “CatEars,” and a new part is instantiated and set to be part of the hat. The position is configured to align with the head of the avatar, enabling the hat to be correctly placed. The part is named “Handle,” a convention for defining attachment points in assets. Further properties, such as the size, bottom and top surfaces, and locked state, are configured to define the physical characteristics of the hat accessory. The mesh associated with the hat is cloned and assigned to the new part, preserving the original appearance of the accessory.

The hat is attached to the avatar by setting its parent to the avatar that interacted with the hat giver, and the attachment position is adjusted to enable the hat to sit correctly on the head of the avatar. Finally, the debounce is reset after a delay to enable subsequent interactions. The script concludes by binding the “onTouched” function to the “Touched” event, such that when an avatar touches the hat giver object, the function is executed and the hat accessory is applied to the avatar.

Thus, FIG. 4B illustrates automatically generated code that enables a hat accessory to be attached to an avatar in a virtual environment. The code generation model uses latent representations of the 3D asset as input to generate contextually relevant code. The script includes functionalities such as event handling, creating parts, positioning them correctly, and enabling the accessory to be attached in a manner consistent with how 3D assets are used within the platform.

### Computing Device

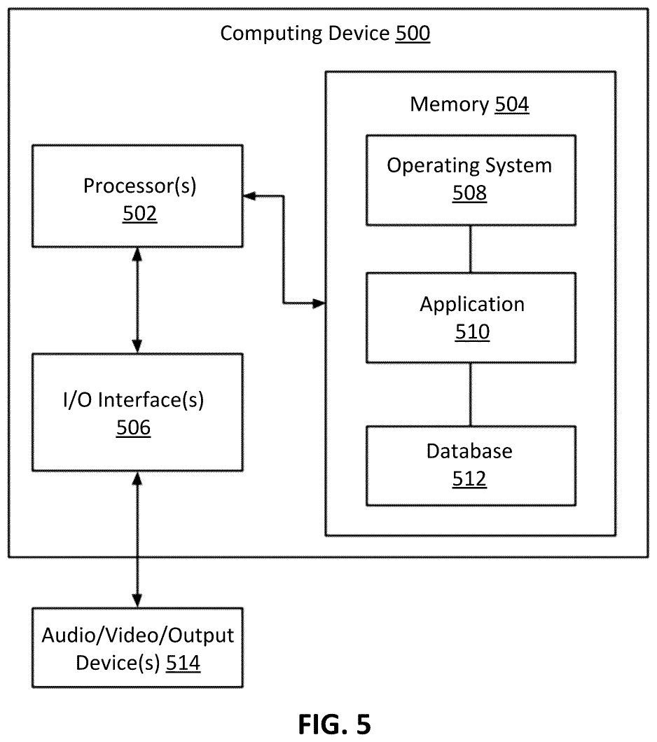

FIG. 5 is a block diagram of an example computing device 500 which may be used to implement one or more techniques described herein. In one example, device 500 may be used to implement a computer device (e.g., 102 and/or 110 of FIG. 1), and perform method implementations described herein. Computing device 500 can be any suitable computer system, server, or other electronic or hardware device. For example, the computing device 500 can be a mainframe computer, desktop computer, workstation, portable computer, or electronic device (portable device, mobile device, cell phone, smartphone, tablet computer, television, TV set top box, personal digital assistant (PDA), media player, game device, wearable device, etc.). In some implementations, device 500 includes a processor 502, a memory 504, input/output (I/O) interface 506, and audio/video input/output devices 514.

Processor 502 can be one or more processors and/or processing circuits to execute program code and control basic operations of the device 500. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 504 is provided in device 500 for access by the processor 502, and may be any suitable computer-readable or processor-readable storage medium, e.g., random access memory (RAM), read-only memory (ROM), Electrical Erasable Read-only Memory (EEPROM), Flash memory, etc., suitable for storing instructions for execution by the processor, and located separate from processor 502 and/or integrated therewith. Memory 504 can store software operating on the server device 500 by the processor 502, including an operating system 507, one or more applications 510, and a database 512 that may store data used by the components of device 500.

Database 512 may store one or more mechanisms, including latent embeddings, feature representations, and configurations for generating code conditioned on 3D virtual assets. In some implementations, database 512 may store information associated with 3D models, such as unique identifiers for each 3D model, metadata describing their geometric and semantic properties, and data representing associated code prompts. The stored data can include latent embeddings, training configurations, and specific representations of the 3D models that are used during the code generation. For example, in a virtual development environment, the database might store the latent representations along with the corresponding generated code, indicating how specific 3D features influenced the code output. In some implementations, database 512 may store other data relevant to the generation, such as code prompt histories, configurations for learned pooling mechanisms, and session information for managing encoding and decoding operations across different stages. Applications 510 can include instructions that enable processor 502 to execute the described techniques, such as managing the encoder-decoder flow, conditioning code generation on latent 3D features, and handling the interaction between visual embeddings and code prompts.

For example, applications 510 can include a module that implements one or more techniques or services described herein, such as generating code conditioned on 3D asset representations, managing encoder-decoder operations, or integrating latent feature embeddings into code prompts. Applications 510 can integrate real-time updates that monitor the progress of code generation, enabling generated outputs to remain contextually aligned with the 3D model features. The applications may employ various mechanisms to enable interaction between visual embeddings and code prompts, including handling different representations, reconciling latent data, and incorporating context during the code generation. Database 512 (and/or other connected storage) can store various data used in the described techniques, including 3D model identifiers, latent embeddings, code prompt histories, and parameters for conditioning code generation on specific 3D features.

Elements of software in memory 504 can alternatively be stored on any other suitable storage location or computer-readable medium. In addition, memory 504 (and/or other connected storage device(s)) can store instructions and data used in the features described herein. Memory 504 and any other type of storage (magnetic disk, optical disk, magnetic tape, or other tangible media) can be considered “storage” or “storage devices.”

I/O interface 506 can provide functions to enable interfacing the server device 500 with other systems and devices. For example, network communication devices, storage devices (e.g., memory and/or data store 120), and input/output devices can communicate via interface 506. In some implementations, the I/O interface can connect to interface devices including input devices (keyboard, pointing device, touchscreen, microphone, camera, scanner, etc.) and/or output devices (display device, speaker devices, printer, motor, etc.).

The audio/video input/output devices 514 can a variety of devices including a user input device (e.g., a mouse, etc.) that can be used to receive user input, audio output devices (e.g., speakers), and a display device (e.g., screen, monitor, etc.) and/or a combined input and display device, which can be used to provide graphical and/or visual output.

For ease of illustration, FIG. 5 shows one block for each of processor 502, memory 504, I/O interface 506, and software blocks of operating system 508 and virtual experience application 510. The blocks may represent one or more processors or processing circuitries, operating systems, memories, I/O interfaces, applications, and/or software engines. In other implementations, device 500 may not have all of the components shown and/or may have other elements including other types of elements instead of, or in addition to, those shown herein. While the online virtual experience server 102 is described as performing operations as described in some implementations herein, any suitable component or combination of components of online virtual experience server 102, client device 110, or similar system, or any suitable processor or processors associated with such a system, may perform the operations described.

Device 500 can be a server device or client device. Example client devices or user devices can be computer devices including some similar components as the device 500, e.g., processor(s) 502, memory 504, and I/O interface 506. An operating system, software and applications suitable for the client device can be provided in memory and used by the processor. The I/O interface for a client device can be connected to network communication devices, as well as to input and output devices, e.g., a microphone for capturing sound, a camera for capturing images or video, a mouse for capturing user input, a gesture device for recognizing a user gesture, a touchscreen to detect user input, audio speaker devices for outputting sound, a display device for outputting images or video, or other output devices. A display device within the audio/video input/output devices 514, for example, can be connected to (or included in) the device 500 to display images pre-and post-processing as described herein, where such display device can include any suitable display device, e.g., an LCD, LED, or plasma display screen, CRT, television, monitor, touchscreen, 3-D display screen, projector, or other visual display device. Some implementations can provide an audio output device, e.g., voice output or synthesis that speaks text.

One or more methods described herein can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating systems.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, the particular implementations are merely illustrative, and not restrictive. Concepts illustrated in the examples may be applied to other examples and implementations.

The functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, blocks, operations, or computations may be presented in a specific order, the order may be changed in different particular implementations. In some implementations, multiple steps or operations shown as sequential in this specification may be performed at the same time.

1. A computer-implemented method comprising:
receiving a three-dimensional (3D) model of a 3D virtual object;
generating a latent representation of the 3D model using a pre-trained encoder, wherein the latent representation of the 3D model encodes semantic and structural information of the 3D model;
providing a text prompt and the latent representation of the 3D model as input to a code generation model, wherein the text prompt comprises a request to generate code with references to the 3D virtual object and wherein the latent representation of the 3D model serves as a conditioning input to the code generation model; and
generating, by the code generation model, the code that, upon execution on a virtual experience platform or a client device, causes the virtual experience platform or the client device to perform one or more actions with reference to the 3D virtual object.

2. The computer-implemented method of claim 1, wherein generating the latent representation of the 3D model using the pre-trained encoder comprises providing a plurality of images depicting respective views of the 3D model to the pre-trained encoder, wherein the latent representation of the 3D model is based on the plurality of images.

3. The computer-implemented method of claim 1, further comprising:
training the code generation model by providing embeddings derived from multiview images of a plurality of prior 3D models.

4. The computer-implemented method of claim 3, wherein each embedding of the embeddings derived from the multiview images is paired with corresponding script data and wherein training the code generation model comprises performing supervised learning based on the embeddings and the corresponding script data.

5. The computer-implemented method of claim 1, further comprising:
training the code generation model by providing embeddings derived from multiview images of a plurality of prior 3D models, wherein the code generation model includes a pre-trained transformer and wherein the training comprises finetuning the pre-trained transformer.

6. The computer-implemented method of claim 1, further comprising, prior to providing the latent representation of the 3D model as an input to the code generation model, compressing the latent representation.

7. The computer-implemented method of claim 6, wherein compressing the latent representation is performed by a perceiver module that implements a learned pooling mechanism.

8. The computer-implemented method of claim 1, wherein the code is in a scripting language, and further comprising storing the code in association with the 3D model of the 3D virtual object, wherein the 3D virtual object is loaded into a virtual experience running on the virtual experience platform or the client device and wherein the code is available for execution in response to one or more events that take place in the virtual experience.

9. A system comprising:
a memory with instructions stored thereon; and
a processing device, coupled to the memory, the processing device configured to access the memory and execute the instructions, wherein the instructions cause the processing device to perform operations comprising:
receiving a three-dimensional (3D) model of a 3D virtual object;
generating a latent representation of the 3D model using a pre-trained encoder, wherein the latent representation of the 3D model encodes semantic and structural information of the 3D model;
providing a text prompt and the latent representation of the 3D model as input to a code generation model, wherein the text prompt comprises a request to generate code with references to the 3D virtual object and wherein the latent representation of the 3D model serves as a conditioning input to the code generation model; and
generating, by the code generation model, the code that, upon execution on a computing device, causes the computing device to perform one or more actions with reference to the 3D virtual object.

10. The system of claim 9, wherein generating the latent representation of the 3D model using the pre-trained encoder comprises providing a plurality of images depicting respective views of the 3D model to the pre-trained encoder, wherein the latent representation of the 3D model is based on the plurality of images.

11. The system of claim 9, wherein the instructions cause the processing device to perform a further operation comprising:
training the code generation model by providing embeddings derived from multiview images of a plurality of prior 3D models.

12. The system of claim 9, wherein the one or more actions comprise modifying a physical property of the three-dimensional virtual object based on simulated interactions within the virtual environment.

13. The system of claim 9, wherein the one or more actions comprise changing a visual, spatial, or behavioral attribute of the three-dimensional virtual object in response to input from an avatar or system event.

14. The system of claim 9, wherein the instructions cause the processing device to perform a further operation comprising:
training the code generation model by providing embeddings derived from multiview images of a plurality of prior 3D models, wherein the code generation model includes a pre-trained transformer and wherein the training comprises finetuning the pre-trained transformer.

15. The system of claim 9, wherein the instructions cause the processing device to perform a further operation comprising:
prior to providing the latent representation of the 3D model as an input to the code generation model, compressing the latent representation.

16. A non-transitory computer-readable medium with instructions stored thereon that, responsive to execution by a processing device, cause the processing device to perform operations comprising:
receiving a three-dimensional (3D) model of a 3D virtual object;
generating a latent representation of the 3D model using a pre-trained encoder, wherein the latent representation of the 3D model encodes semantic and structural information of the 3D model;
providing a text prompt and the latent representation of the 3D model as input to a code generation model, wherein the text prompt comprises a request to generate code with references to the 3D virtual object and wherein the latent representation of the 3D model serves as a conditioning input to the code generation model; and
generating, by the code generation model, the code that, upon execution on a virtual experience platform or a client device, causes the virtual experience platform or the client device to perform one or more actions with reference to the 3D virtual object.

17. The non-transitory computer-readable medium of claim 16, wherein generating the latent representation of the 3D model using the pre-trained encoder comprises providing a plurality of images depicting respective views of the 3D model to the pre-trained encoder, wherein the latent representation of the 3D model is based on the plurality of images.

18. The non-transitory computer-readable medium of claim 16, wherein the instructions cause the processing device to perform a further operation comprising:
training the code generation model by providing embeddings derived from multiview images of a plurality of prior 3D models.

19. The non-transitory computer-readable medium of claim 16, wherein the instructions cause the processing device to perform a further operation comprising:
training the code generation model by providing embeddings derived from multiview images of a plurality of prior 3D models, wherein the code generation model includes a pre-trained transformer and wherein the training comprises finetuning the pre-trained transformer.

20. The non-transitory computer-readable medium of claim 16, wherein the instructions cause the processing device to perform a further operation comprising:
prior to providing the latent representation of the 3D model as an input to the code generation model, compressing the latent representation.
